(19) United States
(12) Patent Application Publication
(10) Pub. No.: US 2025/0162193 A1
(43) Pub. Date: May 22, 2025

(54) FORMING AND PRE-PRESSING STATION FOR FORMING A FIBERBOARD FROM LIGNOCELLULOSIC FIBERS

(71) Applicant: Inter IKEA Systems B.V., Delft (NL)

(72) Inventor: Michael GERMANN, Laatzen (DE)

(21) Appl. No.: 18/837,413

(22) PCT Filed: Feb. 15, 2023
(86) PCT No.: PCT/EP2023/053762

§ 371 Date: Aug. 9, 2024

(30) Foreign Application Priority Data
Feb. 16, 2022 (SE) 2250156-3

(51) Int. Cl. B27N 3/04; B27N 3/00; B27N 3/08; B27N 3/18; B27N 3/24

(52) U.S. Cl. CPC B27N 3/04; B27N 3/007; B27N 3/086; B27N 3/18; B27N 3/24

(57) ABSTRACT

A forming station for forming a fiberboard including compressed lignocellulosic fibers. The forming station includes a press arranged downstream of a forming belt, the forming belt being arranged downstream of a dosing station and at a lower vertical level than a delivery end of the dosing station. Further a pre-press is arranged over a part of the forming belt. The pre-press is arranged to pre-press the layer of dissolved and distributed lignocellulosic fibers by suction into a pre-compressed layer of lignocellulosic fibers.

### FIELD OF THE INVENTION

The present invention relates to a forming and pre-pressing station for a fiberboard comprising compressed lignocellulosic fibers and a binding agent. Further, the present invention relates to a process for the manufacture of a fiberboard.

### BACKGROUND

Fiberboard is an engineered wood product that is made out of lignocellulosic fibers, most typically wood fibers. Wood fibers are pressed, typically with a binder (e.g. a urea-formaldehyde resin), to provide a fiberboard. Fiberboards, especially medium-density fiberboards (MDF), are used a lot in the furniture industry. Types of fiberboard in the art include medium-density fiberboard (MDF), and hardboard (HDF). For pieces of furniture that will be visible, a veneer of wood is often glued onto the fiberboard to give it the appearance of conventional wood. Further, the fiberboard may be provided with a foil, or it may be lacquered, to provide it with an esthetic outer surface. Fiberboards are typically produced from fresh wood. Further, small fibrous particles are typically not used in fiberboard production, as they are known to catch a higher amount of the binder and by this impair the properties of the resulting fiberboard. Re-cycling of fiberboards and especially HDF to produce new fiberboards is known to be difficult.

In the art, re-cycling of lignocellulosic fiber material in furniture in more efficient ways has been addressed. Especially re-cycling of fiber boards, e.g., MDF and HDF boards, has been of interest. Further, it is also of interest to find a better use of all the wooden waste material resulting from furniture production, including small lignocellulosic fibers from e.g., saw dust, than energy recovery. Apart from its use as filler in plastics, fine particulate wooden waste material, e.g., saw dust, is typically not used in other furniture or construction applications.

A process addressing these needs is disclosed in WO 2019/209165, relating to a 0.5 to 7 mm thin fiberboard comprising lignocellulosic fibers and a binding agent pressed together. In this thin fiberboard, at least 50 wt % of the lignocellulosic fibers are small fibers (i.e. fibers passing through a metal wire cloth sieve width of 630 μm).

In producing fiberboards, lignocellulosic fibers are arranged into a uniform layer, which is pressed into a fiberboard. Typically, a forming station is used to arrange the lignocellulosic fibers into a uniform layer to be pressed into a fiberboard. Given the high proportion of small fibers in fiberboards comprising re-cycled fibers, such as the fiberboards disclosed in WO 2019/209165, the processing thereof into a fiberboard may be difficult. Further, the use of recycled materials puts special requirements on the processing, e.g., the possible need to dissolve any remaining lumps of fibers. Especially, the higher density of the lignocellulosic fibers, due to the high proportion of small fibers, puts special requirements on the forming of the lignocellulosic fibers into a layer to be pressed to a fiberboard.

Furthermore, it would be desired to provide a more compact forming station compared to the state of the art solutions. Especially, it would be of interest to dispense with the need for sieving and screening the lignocellulosic fibers in forming them into a layer.

Apart from the material preparation, of importance is also the process of forming the lignocellulosic fibers into a uniform layer; a crucial and quality defining step before pressing the material into a flat or 3D shaped fiberboard. Especially, the material distribution over the width of the board and over time are influencing the product quality and the manufacturing costs. It would thus be of interest to provide a forming technology suitable also for short and heavy fibers to manufacture fiberboards, e.g. fiberboards of a thickness of 7 mm and thinner; especially thin fiberboards comprising small, recycled fibers.

The requirements for thinner boards are slightly different, since less material per area needs to be spread out. Due to the reduced material amount, smaller size and the higher bulk density, any negative forming influences or disturbances have a stronger influence on the final quality.

The forming station should further allow for processing of small lignocellulosic fibers and preferable allow for in a simple manner directing a proportion of the small fibers to the surface of the layer of lignocellulosic to be pressed into the fiberboard, as this is desirable according to WO 2019/209165. As the bulk density of a mix of lignocellulosic fibers with a high proportion of small fibers is much higher (about fivefold higher) than the bulk density of lignocellulosic fibers typically used in fiberboards, standard forming solutions for fiber boards are less suitable.

### SUMMARY

The present invention seeks to provide a process for forming, pre-pressing and eventually pressing lignocellulosic fibers into a fiberboard, such as a fiberboard being 7 mm thick or thinner. Typically, at least 50 wt % (at 6% moisture content) of the lignocellulosic fibers are small fibers, i.e. fibers passing through a metal wire cloth sieve width of 630 μm. Further, at least a share of the lignocellulosic fibers are preferably lignocellulosic fibers re-cycled from fiberboards, e.g. MDF or HDF. The density of the lignocellulosic fibers to be processed may be at least 210 kg/m³. The density of lignocellulosic fibers to be processed is according to an embodiment determined in accordance with the standard “Determination of apparent density of material that can be poured from a specified funnel” EN ISO 60:2000-1. According to an alternative embodiment, the density of lignocellulosic fibers to be processed is according to an embodiment determined in accordance with the standard DIN 51705:2001-06. However, also less dense lignocellulosic fibers may be of interest to use. This kind of fiberboard has been described in WO 2019/209165. Further, the fiberboard being 7 mm thick or thinner, is typically 1 to 6 mm thick, such as 2 to 4 mm thick. The density of the fiberboard may be at least 930 kg/m³.

It was recognized that the specific properties of such a fiberboard put special demands on the production thereof, but also allows for simplifying and shortening the forming and pre-pressing steps to achieve a layer with reduced min/max weight tolerance. Especially, the combination of short and dense fibers (the density of recycled lignocellulosic fibers to be processed is typically at least 210 kg/m³) and low thickness of the fiberboard allows for this. The main enablers for an altered process comes from:
Recycled fibers being short, heavy and dense, and hence less sensitive against compression; and
A reduced need for separation for different fiber shapes or weights (typically at least 95 wt % (at 6% moisture content) of the lignocellulosic fibers passes through a metal wire cloth sieve width of 3 mm).

A high proportion of smaller fibers, resulting in higher density of the lignocellulosic fibers, implies that the throughput volume over time will be lower. It was recognized that this in turn implies that the distance over which the fibers are moving freely and are not guided in processing them into a fiberboard, such as the fibers falling vertically downwards, may be shortened. Further, also compressing recycled fibers that are short and dense turned out to be easier than compressing virgin fibers. Without being bound by any theory, it is believed that properties of the recycled fibers imply that less air needs to be aspirated in pre-compressing the fibers. Further, it was found that the higher bulk density of the small, recycled lignocellulosic fibers allows the lignocellulosic fibers to be dispensed more easily and quickly in forming them into a uniform layer.

Accordingly, based on these conclusions, according to a first aspect of the invention, there is provided a forming and pre-pressing station for forming a fiberboard comprising compressed lignocellulosic fibers. The forming and pre-pressing station comprises a press, typically a belt press, for pressing a pre-compressed layer of lignocellulosic fibers into a fiberboard. The pre-press is arranged downstream of a forming belt. The forming belt serves to form a layer of the lignocellulosic fibers such that the layer may be pre-pressed into a fiberboard. The forming belt is in turn arranged downstream of a dosing station. The forming and the dosing station may be arranged in an overlapping manner. Lignocellulosic fibers may be fed from the dosing station to the forming belt. Accordingly, the forming belt may be arranged at least partly at a lower vertical level than a delivery end of the dosing station. Preferably, the difference in vertical level between the forming belt and the delivery end of the dosing station, in particular the difference in vertical level between the top of the receiving end of the forming belt and the top of the delivery end of the dosing station, is less than 50 cm, preferably less than 30 cm, such as in the range 5 to 30 cm. In the art, the overall the distance between the top of the dosing belt and the top of the forming belt is typically at least 100 cm. By decreasing this distance, uneven distribution of small particles by e.g. turbulence is significantly reduced. Further, by this arrangement, lignocellulosic fibers may be transported from the dosing station to the belt press via the forming belt.

Further, at least one rotatable forming and dissolving roller may be arranged at an end of the dosing station. The forming and dissolving roller serves to feed lignocellulosic fibers to the forming belt. In order to dissolve and distribute the lignocellulosic fibers into a layer on the forming belt, the forming and dissolving roller is arranged to engage with lignocellulosic fibers from the dosing station. The forming and dissolving roller may be a spike roller.

Further, a pre-press is arranged over a part of the forming belt. The pre-press is arranged to pre-press the layer of dissolved and distributed lignocellulosic fibers on the forming belt by means of suction into a pre-compressed layer of lignocellulosic fibers before being fed to the press. Further, the pre-press may be arranged to apply mechanical compression force to lignocellulosic fibers transported by the forming belt by pressing them towards the forming belt.

This arrangement may be very compact, and has several functions in one unit, e.g. dissolving lignocellulosic fibers, arranging them into a layer, and pre-pressing the layer.

According to an embodiment, the pre-press comprises an air-permeable mesh belt with a lower side arranged to be in contact with lignocellulosic fibers transported by the forming belt. The inner side of the mesh belt (being opposite to the outer side of the mesh belt arranged to be in contact with lignocellulosic fibers transported by the forming belt) is arranged in communication with a first vacuum box configured to provide a suction across the mesh belt. By this arrangement, the lignocellulosic fibers may be pre-pressed over at least a portion of the lower side of the mesh belt into the pre-compressed layer of lignocellulosic fibers by evacuating air from the fibers. Further, the pre-press is typically arranged to apply mechanical compression force to lignocellulosic fibers transported by the forming belt by pressing the mesh belt towards the forming belt.

As already stated, the press may be a belt press. The belt press may be arranged to heat the pre-compressed layer of lignocellulosic fibers in pressing them into a fiberboard. The fibers may be heated to 150 to 250° C., e.g. about 180° C. A belt press and the forming belt may be arranged in a non-overlapping manner to leave a gap in between them. In such an arrangement, the air-permeable mesh belt of the pre-press may be arranged in an overlapping manner over a lower belt of the belt press as well as over the forming belt. By arranging the air-permeable mesh belt in an overlapping manner, the lignocellulosic fibers may be fed from the forming belt to the belt press by means of the air-permeable mesh belt, as the first vacuum box creates suction causing the lignocellulosic fibers to stick fast to the mesh belt. While not necessary, such an arrangement is preferred if the belt press and the forming belt are arranged at the same vertical level.

Typically, the pre-press comprises a first roller, arranged at a receiving end of the pre-press, and a second roller, arranged at a delivery end of the pre-press. The receiving end faces the dosing station, whereas the delivery end faces the belt press. The air-permeable mesh belt is arranged around said rollers and typically driven by at least one of the rollers. The first roller is hollow. Its peripheral surface, the roller casing, is air permeable, such that air may be sucked into the roller through the air-permeable mesh belt. A suction is applied over a part of the circumference of the first roller by means of a second vacuum box arranged within the first roller and configured to provide a suction across the air-permeable mesh belt. Further, the second roller is preferably hollow. Its peripheral surface, the roller casing, may be permeable, such that air may be pushed from in its interior through the air-permeable mesh belt. Further, the second roller may be arranged for releasing the pre-compressed layer of lignocellulosic fibers by means of an air pressured box arranged within the second roller.

By applying a force to an axis of the first roller, a mechanical compression force may be applied to the lignocellulosic fibers transported by the forming belt by pressing the mesh belt by means of the first roller towards the forming belt.

According to an embodiment, the pre-press may further comprise a third roller. Similar to the first roller, the third roller may be hollow and a suction may be applied over a part of its circumference by means of a third vacuum box arranged within the third roller. The third roller is arranged over the over a part of the forming belt and downstream of the dosing station. The third roller is further arranged in between the first roller (if present) and the dosing station. Typically, the third roller is arranged separately from the mesh belt. Similar to the first roller, a force may be applied to an axis of the third roller to press the third roller towards the forming belt, thereby applying a mechanical compression force on the lignocellulosic fibers transported by the forming belt by pressing the third roller and the mesh belt towards the forming belt. Further, a second air-permeable mesh belt may be arranged around the third roller and a fourth roller, similarly to the air-permeable mesh belt that may be arranged around the first and second roller. Such a second air-permeable mesh belt may be driven by the third roller and/or the fourth roller.

According to some embodiments, the pre-press comprises a second air-permeable mesh belt arranged around the third roller and a fourth roller, as well as the air-permeable mesh belt that may be arranged around the first and second roller.

According to some alternative embodiments, the air-permeable mesh belt arranged around the first and second roller may be dispensed with. According to such an embodiment, the pre-press may at least comprise an air-permeable mesh belt arranged around the third roller and the fourth roller.

Further, a top cover extending from the dosing station to the pre-press over a part of the forming belt not arranged under the pre-press may be present. A forming chamber is then formed in between the forming belt and the top cover. By providing a forming chamber, fibers may be prevented from whirling up. Further, according to an embodiment, the forming and pre-pressing station is operated, e.g. by means of the pre-press, to direct fine fibers in the forming chamber to the surface of the layer of lignocellulosic fibers to be pre-pressed. In this manner, the finest fibers may form a surface layer on the fiberboard.

According to an embodiment, the pre-press comprises a wetting arrangement for wetting an upper and/or a lower side of the layer of lignocellulosic fibers before being fed to the belt press. Further, the pre-press may comprise a heating arrangement, such as a steaming arrangement, for pre-heating the layer of lignocellulosic fibers before being fed to the press.

According to an embodiment, the dosing station comprises a dosing belt. As discussed above, a rotatable forming and dissolving roller may be arranged at an end of the dosing station to feed lignocellulosic fibers to the forming belt. The rotatable forming and dissolving roller may be arranged to rotate with a tangential speed higher than a linear speed of the dosing belt. The rotation speed of the forming and dissolving roller influences the dropping curve of the lignocellulosic fibers. If the forming and dissolving roller rotates with a tangential speed higher than a linear speed of the dosing belt, it will accelerate the lignocellulosic fibers.

The forming and dissolving roller will assist in fluidizing the lignocellulosic fibers. The effect of the dissolving roller is affected inter alia by the diameter of the forming and dissolving roller and its position relative to the dosing belt. Also these features will affect the dropping curve of the lignocellulosic fibers.

By adjusting the dropping curve, more or less separation of fine fibers may be achieved to support either a homogeneous layer of lignocellulosic fibers to be pre-pressed or a heterogeneous layer of lignocellulosic fibers to be pre-pressed, the finest fibers forming a surface layer.

In some embodiments, the forming and dissolving roller may be arranged at a higher vertical level than the delivery end of the dosing station and may be arranged to rotate counter to the rotation of a first dosing roller, which may drive the dosing belt. In other embodiments, the forming and dissolving roller may be arranged at a lower vertical level than the delivery end of the dosing station and may be arranged to rotate in the same sense or direction as the first dosing roller.

In some embodiments, a second forming and dissolving roller is arranged below a first forming and dissolving roller. The second forming and dissolving roller may be arranged on essentially the same vertical level as the delivery end of the dosing station, or at a lower vertical level than the delivery end of the dosing station. In such embodiments, the first forming and dissolving roller is arranged at a higher vertical level than the delivery end of the dosing station.

Further, the system may optionally comprise a main fiber supply unit for feeding, such as gravimetrically feeding, lignocellulosic fibers to the dosing belt. In addition, the system may optionally comprise a first supplementary fiber supply unit. The first supplementary fiber supply unit may be arranged upstream of the dosing station. Further, the system may optionally comprise a second supplementary fiber supply unit. The second supplementary fiber supply unit may be arranged downstream of the delivery end of the dosing station and upstream of the pre-press. By combining a main fiber supply unit and at least one supplementary fiber supply unit, a multi layered fiberboard comprising compressed lignocellulosic fibers may be provided. The at least one supplementary fiber supply unit may provide fibers for one or more surface layers whereas the main fiber supply unit may provide fibers for a main layer. If two surface layers are provided, the main layer may be a core layer. The fibers in the surface layer may be fibers of a smaller diameter than the fibers of the main layer, comprising fibers coarser then the fibers in the surface layers. Optionally, the fibers in the surface layer may comprise fines.

Furthermore, a profile correction system is preferably arranged upstream, and/or downstream, the forming and dissolving roller. By means of such a profile correction system, the lignocellulosic fibers on the dosing belt may be arranged to a layer of lignocellulosic fibers with uniform height before reaching the forming and dissolving roller. Alternatively, or in addition, a profile correction system may be arranged downstream of the forming and dissolving roller. By means of such a profile correction system, the lignocellulosic fibers on the forming belt may be arranged to a layer of lignocellulosic fibers with uniform height before reaching the pre-press.

According to a second aspect there is provided a process for forming and pre-pressing lignocellulosic fibers to eventually provide a fiberboard comprising compressed lignocellulosic fibers. While not being restricted thereto, such a process may be performed by the present forming and pre-pressing station. The method may comprise the steps of
dissolving lignocellulosic fibers from a dosing station and distributing them into a layer on a forming belt, the forming belt being present at a lower vertical level than at least a delivery end of the dosing station;
pre-pressing the layer of dissolved and distributed lignocellulosic fibers on the forming belt into a pre-compressed layer of lignocellulosic fibers by applying suction from above; and
pressing the compressed layer of lignocellulosic fibers to provide fiberboard.

As such a process may be performed by the present forming and pre-pressing station, aspects disclosed herein in relation to the forming and pre-pressing station are equally applicable to the process for forming and pre-pressing lignocellulosic fibers to eventually provide a fiberboard.

In the process, the lignocellulosic fibers distributed on the forming belt further may be compressed between an air-permeable mesh belt and the forming belt. The suction may be applied to evacuate air from the layer of lignocellulosic fibers through the air-permeable mesh belt, such as by means of a vacuum box. Optionally, the air-permeable mesh applies mechanical compression force to the lignocellulosic fibers by pressing them towards the forming belt.

The pre-compressed layer of lignocellulosic fibers may be pressed into a fiberboard by a belt press. The pre-compressed layer of lignocellulosic fibers may be fed to the belt press by the air-permeable mesh belt.

According to an embodiment, the dosing station may comprise a dosing belt. At least one rotatable forming and dissolving roller may be arranged at an end of the dosing station for dissolving lignocellulosic fibers leaving the dosing belt and feeding them to the forming belt. The rotatable forming and dissolving roller may be a spike roller. The spike roller may rotate at a tangential speed higher than a linear speed of the dosing belt conveying the lignocellulosic fibers to the spike roller.

The present process is especially useful in processing lignocellulosic fibers recycled from MDF or HDF. Thus, at least 25 wt % of the lignocellulosic fibers processed may originate from re-cycled MDF and/or HDF. Further, at least 95 wt % (at 6% moisture content) of the lignocellulosic fibers may pass through a metal wire cloth sieve width of 3 mm, and at least 50 wt % of the lignocellulosic fibers may pass through a metal wire cloth sieve width of 630 μm. Furthermore, the lignocellulosic fibers may have a density of at least 210 kg/m³. The lignocellulosic fibers optionally are mixed with a binding agent before being pressed or pre-pressed.

According to an embodiment, the lignocellulosic fibers are heated and/or wetted before being pressed into a fiberboard.

According to an embodiment, the present process is used to provide a thin particleboard, e.g. a particleboard having a total thickness of 0.5 to 7 mm, such as 1 to 5 mm. Further, it may be used to provide a fiberboard having a density of at least 930 kg/m³. The process may thus be used to provide a thin (0.5 to 7 mm, such as 1 to 5 mm) particleboard having a density of at least 930 kg/m³

### BRIEF DESCRIPTION OF THE DRAWINGS

These and other aspects, features and advantages of which the invention is capable of will be apparent and elucidated from the following description of embodiments of the present invention, reference being made to the accompanying drawings, in which:

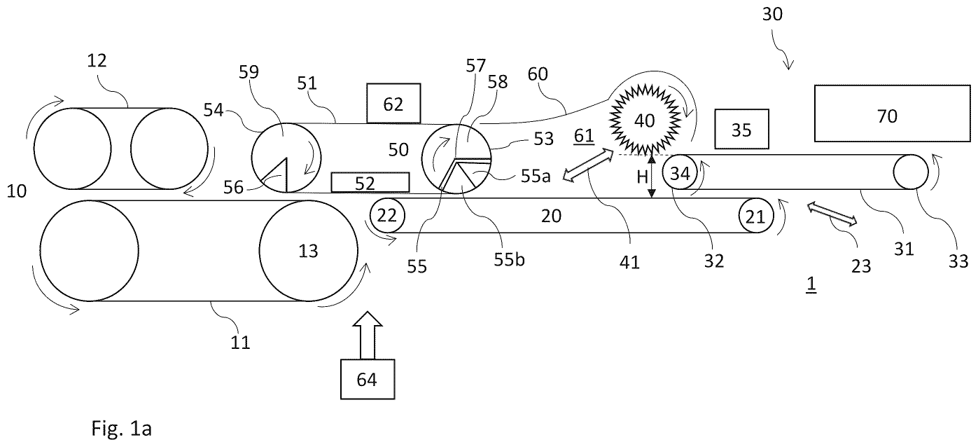

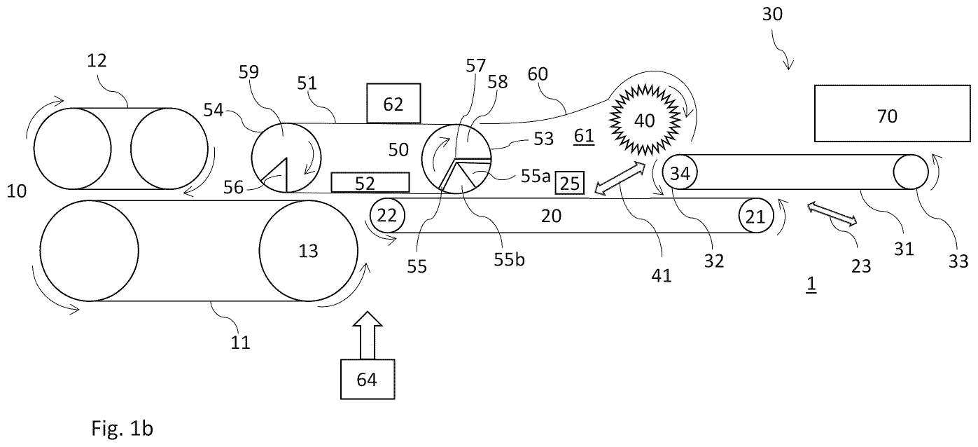

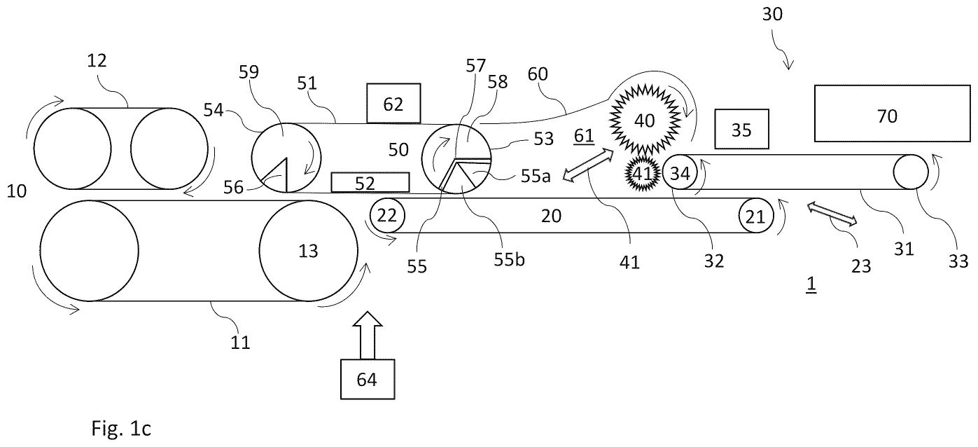

In FIG. 1a a forming and pre-pressing station for forming a fiberboard, according to one embodiment, is shown;

In FIG. 1b a forming and pre-pressing station for forming a fiberboard, according to one embodiment, is shown;

In FIG. 1c a forming and pre-pressing station for forming a fiberboard, according to one embodiment, is shown;

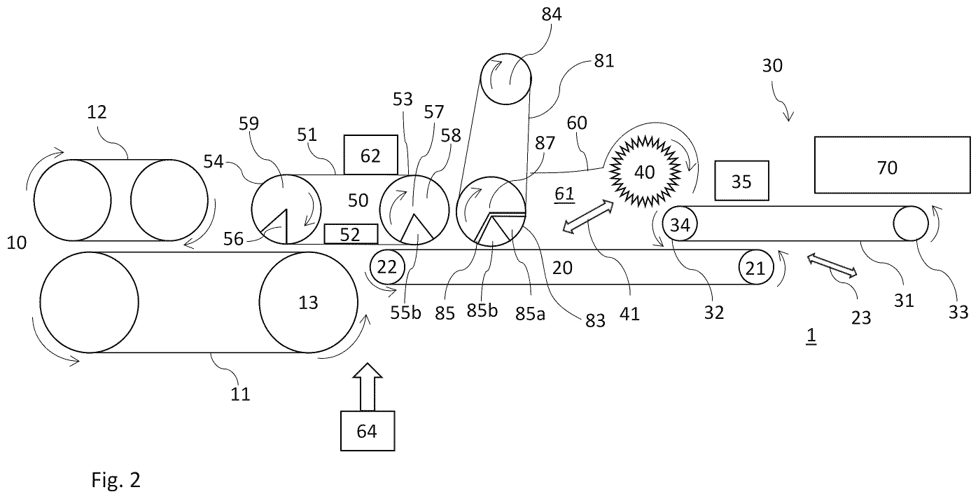

In FIG. 2 a forming and pre-pressing station for forming a fiberboard, according to one embodiment, is shown;

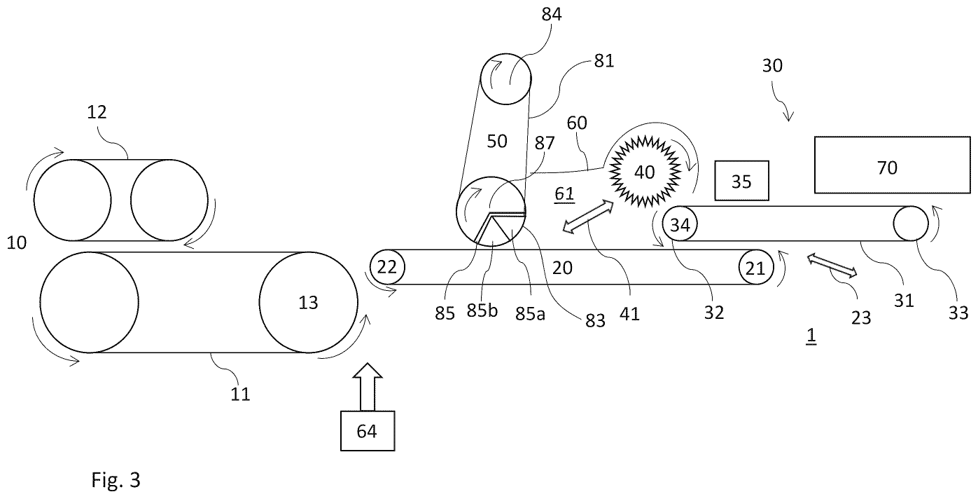

In FIG. 3 a forming and pre-pressing station for forming a fiberboard, according to one embodiment, is shown; and

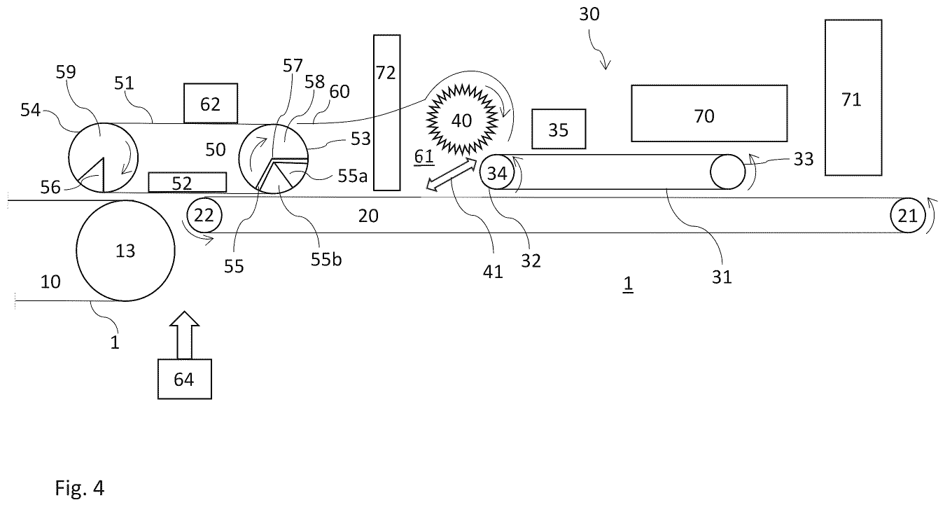

In FIG. 4 a forming and pre-pressing station for forming a fiberboard, according to one embodiment, is shown.

### DETAILED DESCRIPTION

In FIG. 1a, a forming and pre-pressing station 1 for forming a fiberboard comprising compressed lignocellulosic fibers according to an embodiment is shown. In the forming and pre-pressing station 1, the lignocellulosic fibers may be fed gravimetrically from a main fiber supply unit 70 to a dosing station 30 comprising a dosing belt 31, a first dosing roller 32 and a second dosing roller 33. Once fed to the dosing belt 31, the fibers may be transported to a delivery end 34 of the dosing station 30, which acts as part of a conveyer. In particular, the dosing belt 31 serves to feed lignocellulosic fibers to a forming belt 20. The difference in vertical level H between the forming belt 20 and the delivery end 34 of the dosing station 30 is indicated in FIG. 1a. The difference in vertical level H between the forming belt 20 and the delivery end 34 is the vertical distance from the top of the upper side of the delivery end 34 of the dosing station 30 to the upper side of the underlying forming belt 20. The delivery end 34 of the dosing station 30 may comprise the first dosing roller 32, which may drive the dosing belt 31. The dosing belt 31 may additionally or alternatively be driven by the second dosing roller 33, arranged at the opposite end of the dosing belt 31. The main fiber supply unit 70 may feed the lignocellulosic fibers to the dosing belt 31 by means of a swivel belt or for example a crosswise moving chute. The swivel belt may be a belt with a fixed point at a receiving end and an oscillating point at an opposite delivery end, serving to distribute the lignocellulosic fibers evenly over the width of the dosing belt 31. Further, an oscillating screw could replace the swivel belt, a crosswise moving chute, and/or a static cascade of dividing brackets.

At the delivery end 34 of the dosing station 30, a forming and dissolving roller 40 may be arranged to receive the fibers transported to the delivery end 34 by the dosing belt 31. As shown in FIG. 1a, in order to arrange the lignocellulosic fibers on the dosing belt 31 to a layer of lignocellulosic fibers with uniform height (or a desired profile), before reaching the forming and dissolving roller 40, the dosing belt 31 may be provided with a profile correction system 35 which is arranged upstream the forming and dissolving roller 40. The rotatable forming and dissolving roller 40 is arranged essentially downstream of the dosing station 30 and serves to feed lignocellulosic fibers to the forming belt 20. The roller 40 is arranged to engage with the lignocellulosic fibers transported on the dosing belt 31, to dissolve the lignocellulosic fibers, and to distribute them onto the forming belt 20.

Further, in order to arrange the lignocellulosic fibers on the forming belt 20 to a layer of lignocellulosic fibers with more uniform height (or a desired profile), before reaching a pre-press 50, the forming belt 20 may be provided with a profile correction system, which is arranged downstream the forming and dissolving roller 40. As show in FIG. 1b, a profile correction system 25 may thus, according to one embodiment, be arranged downstream of the forming and dissolving roller 40. It is arranged upstream of the pre-press 50.

In some embodiments, the forming and pre-pressing station 1 comprises a first and a second profile correction system (not shown in FIG. 1). In such embodiments, a first profile correction system 35 may be arranged upstream the forming and dissolving roller 40, whereas a second profile correction system 25 may be arranged downstream of the forming and dissolving roller 40. In operation, the forming and dissolving roller 40 typically rotates with a tangential speed higher than the linear speed of the dosing belt 31, whereby the speed of the lignocellulosic fibers is accelerated and the lignocellulosic fibers are dissolved and distributed into a layer on the forming belt 20. The rotation speed of the forming and dissolving roller 40 influences the dropping curve of the lignocellulosic fibers. That is to say, the trajectory of the lignocellulosic fibers as they drop from the dosing belt 31 to the forming belt 20 via the forming and dissolving roller 40 is affected by the rotation speed of the forming and dissolving roller 40. If the forming and dissolving roller 40 rotates with a tangential speed higher than a linear speed of the dosing belt 31, it will accelerate the lignocellulosic fibers.

The forming and dissolving roller 40 assists in fluidizing the lignocellulosic fibers. The effect of the forming and dissolving roller is affected inter alia by the diameter of the forming and dissolving roller 40 and its position relative to the dosing belt 31. These features will also affect the dropping curve of the lignocellulosic fibers. By adjusting the dropping curve, more or less separation of fine fibers may be achieved to support either a homogeneous layer of lignocellulosic fibers to be pre-pressed or a heterogeneous layer of lignocellulosic fibers to be pre-pressed, the finest fibers forming a surface layer.

In some embodiments, the forming and dissolving roller 40 may be arranged at a higher vertical level than the delivery end 34 of the dosing station 30, as shown in FIG. 1a. In these embodiments, the forming and dissolving roller 40 may be arranged to rotate counter to the rotation of the first dosing roller 32 to feed lignocellulosic fibers to the forming belt 20. In other embodiments, the forming and dissolving roller 40 may be arranged at a lower vertical level than the delivery end 34 of the dosing station 30. In these embodiments, the forming and dissolving roller 40 may be arranged to rotate in the same sense or direction as the first dosing roller 32 to feed lignocellulosic fibers to the forming belt 20.

The forming and dissolving roller 40 is typically a spike roller 40. The diameter of the spike roller 40 may be 250 to 1000 mm. A spike roller with a diameter of 500 mm may rotate with a speed of 30 to 500 rpm.

Further, as shown in FIG. 1c, more than one forming and dissolving roller 40 may be present. A second forming and dissolving roller 41 may be arranged below a first forming and dissolving roller 40. This second forming and dissolving roller 41 may be arranged on essentially the same vertical level as the delivery end 34 of the dosing station 30. In such an embodiment, the first forming and dissolving roller 40 is arranged at a higher vertical level than the delivery end 34 of the dosing station 30. Use of more than one forming and dissolving roller may improve the dissolving of the fibers.

The forming belt 20 extends downstream of the dosing station 30, at least partly at a lower vertical level than at least the delivery end 34 of the dosing station 30. In particular, the top of a receiving end 21 of the forming belt 20 may be at a lower vertical level than the top of the delivery end 34 of the dosing station 30. In some embodiments, the entire forming belt 20 is arranged at a lower vertical level than the entire dosing belt 31. In some embodiments, the forming belt 20 is inclined upwards, such that the receiving end 21 of the forming belt 20 is at a lower vertical level than a delivery end 22 of the forming belt 20. Further, the forming belt 20 and the dosing belt 31 are arranged in an overlapping manner, i.e. a delivery end 34 of the dosing station 30 is arranged downstream of the receiving end 21 of the forming belt 20, as illustrated in FIGS. 1a-c. In some embodiments, the forming belt 20 extends upstream of the dosing station 30, as can be seen in FIG. 4. The forming belt 20 is arranged to act as a conveyer and as such to transport the lignocellulosic fibers to a belt press 10 for pressing lignocellulosic fibers into a fiberboard. In the gap between the dosing belt 31 and the forming belt 20, an air flow 23 may be applied to direct small lignocellulosic fibers to the bottom of the layer of lignocellulosic fibers on the forming belt 20, thereby forming a heterogenic layer of lignocellulosic fibers, having small fibers at its lower surface, thereby providing for a very even surface of the final fiberboard. An air flow 41 may also be provided from the forming and dissolving roller 40. The air flows 23, 41 may be in a direction towards the forming belt 20, or away from the forming belt 20. In this way, the air flows 23, 41 help to carry fine fibers further downstream or upstream, to enable a fine layer to be formed on one side.

A pre-press 50 is arranged over a downstream part of the forming belt 20. The pre-press 50 is arranged to pre-compress the layer of lignocellulosic fibers into a pre-compressed layer of lignocellulosic fibers by means of suction. In order to assist small fibers to eventually settle on the forming belt 20, i.e. to prevent them from whirling up, a top cover 60 extends from the delivery end 34 of the dosing station 30 to the pre-press 50 over a part of the forming belt 20 not arranged under the pre-press 50, whereby a forming chamber 61 is formed in between the forming belt 20 and the top cover 60. In embodiments where the forming and dissolving roller 40 is present, the top cover 60 may also extend over the forming and dissolving roller 40.

The pre-press 50 comprises an air-permeable mesh belt 51 with a lower side arranged to be in contact with the layer of lignocellulosic fibers transported by the forming belt 20. Typically, the pre-press 50 and the forming belt 20 are arranged to mechanically compress the layer of lignocellulosic fibers in between them. The air-permeable mesh belt 51 is essentially non-permeable to lignocellulosic fibers. An inner side of the mesh belt 51 is arranged in communication with a first vacuum box 52. The first vacuum box 52 is configured to provide a suction across the air-permeable mesh belt 51, whereby the lignocellulosic fibers may be pre-pressed over at least a portion of the lower side of the mesh belt 51 into a pre-compressed layer of lignocellulosic fibers by evacuating air therefrom. The first vacuum box 52 is arranged between a first roller 53 and a second roller 54 of the pre-press 50. The mesh belt 51 is arranged around and may be driven by the rollers 53, 54. The first roller 53 is arranged at a receiving end 58 of the pre-press 50 and the second roller 54 is arranged at a delivery end 59 of the pre-press 50. In some embodiments, the first roller 53 and the second roller 54 have the same diameter. In other embodiments, the first roller 53 may have a larger diameter than the second roller 54. The receiving end 58 faces the dosing station 30 and the delivery end 59 faces the belt press 10. The forming belt 20 is arranged to transport the layer of dissolved and distributed lignocellulosic fibers to the pre-press 50, and partly under it, to bring the layer of lignocellulosic fibers into to contact with the air-permeable mesh belt 51. The first roller 53 of the pre-press 50 is hollow and a suction may be applied over a part of its circumference by means of a second vacuum box 55 arranged within the first roller 53. The second vacuum box 55 comprises a first vacuum chamber 55a and a second vacuum chamber 55b, and is configured to provide a suction across the air-permeable mesh belt 51. The first roller 53 is arranged to rotate, whereas the second vacuum box 55 is stationary. By means of the first vacuum chamber 55a, arranged upstream of the second vacuum chamber 55b, small fibers whirling round in the forming chamber 61 are directed to the air-permeable mesh belt 51 and may settle on top of the layer of lignocellulosic fibers. Further, the first roller 53 of the pre-press 50 may suck in a flow of air resulting from the rotating forming and dissolving roller 40. The second vacuum chamber 55b evacuates air from the layer of lignocellulosic fibers to initiate the compression of the layer of lignocellulosic fibers. Further, by applying a mechanical compression force to a center axis 57 of the first roller 53, the layer of lignocellulosic fibers is compressed between the first roller 53 and the forming belt 20. Further, the second roller 54 is also hollow and is arranged for releasing the pre-compressed layer of lignocellulosic fibers by means of an air pressurized box 56 arranged within the second roller 54. The second roller 54 is arranged to rotate, whereas the air pressurized box 56 is stationary and arranged to apply a slight counter force over a part of the circumference of the second roller 54 to release the pre-compressed layer of lignocellulosic fibers from the mesh belt 51 and to keep the mesh belt 51 clean. Further, a cleaning arrangement 62 may be arranged above the pre-press 50 for removing remaining fibers from the mesh belt 51 before reaching the first roller 53.

The belt press 10 and the forming belt 20 are arranged in a non-overlapping manner, i.e. the delivery end 22 of the forming belt 20 is arranged upstream of a receiving end 13 of the belt press 10. However, the air-permeable mesh belt 51 is arranged in an overlapping manner over a lower belt 11 of the belt press 10 as well as over the forming belt 20. As the layer of lignocellulosic fibers are sucked to, and thereby temporarily fixed to, the lower side of the air-permeable mesh belt 51 by means of the first vacuum box 52, the lignocellulosic fibers may be transported from the forming belt 20 to the belt press 10 by means of the air-permeable mesh belt 51. In the embodiments shown in FIGS. 1a-c, the lower belt 11 and the forming belt 20 are arranged at the same vertical level. However, as the layer of lignocellulosic fibers is sucked to the lower side of the air-permeable mesh belt 51 and transported by it, the lower belt 11 and the forming belt 20 may be arranged at different vertical levels. Further, the first vacuum box 52 may be operated to discard material, for example at a start-up of the process. If the first vacuum box 52 is inactivated, i.e. the suction is released, the lignocellulosic fibers will not be transferred to the belt press 10, but be dropped in between lower belt 11 of the belt press 10 and the forming belt 20. Other means for discarding lignocellulosic fibers comprise operating the forming belt 20 in reverse direction to transport lignocellulosic fibers towards the receiving end 21 and discard lignocellulosic fibers downstream of the receiving end 21.

In order to further adapt the layer of lignocellulosic fibers before being fed to the belt press 10, the pre-press 50 may be provided with a wetting arrangement 64 for wetting an upper and/or a lower side of the layer of lignocellulosic fibers before being fed to the belt press 10. As an example, a lower side of the layer of lignocellulosic fibers may be wetted in between the lower belt 11 and the forming belt 20. Similarly, an upper side of the layer of lignocellulosic fibers may be wetted in between an upper belt 12 of the belt press 10 and the forming belt 20. Further, the pre-press 50 may comprise a heating arrangement (not shown in FIGS. 1a-c), such as a steaming arrangement, for pre-heating the layer of lignocellulosic fibers before being fed to the belt press 10.

As already explained, the pre-pressing station 1 further comprises the belt press 10 for pressing lignocellulosic fibers into a fiberboard. The belt press 10 comprises the lower belt 11 and the upper belt 12. The lower belt 11 extends upstream of the upper belt 12. In between the lower belt 11 and the upper belt 12, the pre-compressed layer of lignocellulosic fibers may be pressed into a fiber board.

In FIG. 2, a forming and pre-pressing station 1 for forming a fiberboard comprising compressed lignocellulosic fibers according to another embodiment is shown. The forming and pre-pressing station 1 according to this embodiment is similar to the one in FIG. 1. The pre-press 50 however comprises a third roller 83 that is hollow and a suction may be applied over a part of its circumference by means of a third vacuum box 85 arranged within the first roller 83. The third roller 83 is arranged in between the first roller 53 and the dosing station 30. The top cover 60 extends from the dosing station 30 to the third roller 83. Further, the pre-press 50 comprises a fourth roller 84. A second air-permeable mesh belt 81 may be arranged around the third roller 83 and the fourth roller 84. The second air-permeable mesh belt 81 may be driven by the third roller 83 and/or the fourth roller 84.

The third vacuum box 85 comprises a first vacuum chamber 85a and a second vacuum chamber 85b. The third roller 83 is arranged to rotate, whereas the second vacuum box 85 is stationary.

By means of the first vacuum chamber 85a, arranged upstream of the second vacuum chamber 85b, small fibers whirling round in the forming chamber 61 are directed to the periphery of the third roller 83 and may settle on top of the layer of lignocellulosic fibers. Further, the third roller 83 of the pre-press 50 may, by means of the second vacuum chamber 85b, suck in a flow of air resulting from the rotating forming and dissolving roller 40. According to this embodiment, the first vacuum chamber 55a of the second vacuum box 55 in FIG. 1 may be omitted, as the third vacuum box 85 comprises a first vacuum chamber 85a. Similar to the first roller 53, by applying a mechanical compression force to a center axis 87 of the third roller 83, the layer of lignocellulosic fibers may be compressed between the third roller 83 and the forming belt 20. The layer of lignocellulosic fibers may then be further compressed by the first roller 53 and the mesh belt 51.

In FIG. 3, a forming and pre-pressing station 1 for forming a fiberboard comprising compressed lignocellulosic fibers according to a further alternative embodiment is shown. The forming and pre-pressing station 1 according to this embodiment is similar to the one in FIG. 2. However, the pre-press 50 according to this embodiment does not comprise the first vacuum box 52, the first roller 53, the second roller 54, the mesh belt 51 arranged around the first and the second rollers 53, 54 or any of the parts associated therewith. The pre-press 50 comprises the third roller 83, the fourth roller 84, the second air-permeable mesh belt 81, and the parts associated therewith. In order to provide the pre-compressed layer of lignocellulosic fibers with sufficient structural integrity to allow for unassisted passage from the forming belt 20 to the lower belt 11, it may be necessary to apply certain measures, such as incorporation of a portion of larger lignocellulosic fibers (i.e. 2 to 4 mm), adding a tackifier (e.g. an adhesive or moisture) to the lignocellulosic fibers and/or increasing the pre-compression of the lignocellulosic fibers.

According to this embodiment, lignocellulosic fibers may be discarded by operating the forming belt 20 in a reverse direction to transport lignocellulosic fibers towards the receiving end 21 and discard lignocellulosic fibers downstream of the receiving end 21. Further, lignocellulosic fibers may be discarded by retracting the delivery end 22 of forming belt 20, thereby increasing the distance between the forming belt 20 and the lower belt 11 of the belt press 10.

In FIG. 4, a forming and pre-pressing station 1 for forming a multi layered fiberboard comprising compressed lignocellulosic fibers according to an embodiment is shown. The belt press 10 is only partly shown in this figure. The forming and pre-pressing station 1 according to this embodiment is similar to the one in FIG. 1a. According this embodiment, the forming and pre-pressing station 1 may comprise a first supplementary fiber supply unit 71 arranged upstream of the dosing station 30 and the main fiber supply unit 70. In such an embodiment, the forming belt 20 may extend upstream of the dosing station 30. The first supplementary fiber supply unit 71 may be arranged above the forming belt 20. Thus, fibers from the first supplementary fiber supply unit 71 may be fed gravimetrically onto the forming belt 20. Further, a second supplementary fiber supply unit 72 may be arranged downstream of the dosing station 30 and the main fiber supply unit 70. The second supplementary fiber supply unit 72 is typically arranged downstream of the delivery end 34 of the dosing station 30 and upstream of the pre-press 50. Further, the second supplementary fiber supply unit 72 may be arranged above the forming belt 20. Thus, fibers from the second supplementary fiber supply unit 72 may be fed gravimetrically onto the forming belt 20.

The first supplementary fiber supply unit 71 may be used to feed fibers to form a first outer layer in a multi layered fiberboard. The second supplementary fiber supply unit 72 may be used to feed fibers to form a second outer layer in a multi layered fiberboard. The outer layers may enclose a core layer. The fibers in the core layer are supplied by the main fiber supply unit 70. In short, fibers for a first outer layer are supplied from the first supplementary fiber supply unit 71 to the forming belt 20 such that they are present thereon as a first layer when fibers from the dosing station 30 are distributed to the forming belt 20 to provide a second layer on top of the first layer. Subsequently, fibers from the second supplementary fiber supply unit 72 are supplied on top of the second layer as a third layer, the second layer thus forming a core layer. In alternative embodiments, only the first supplementary fiber supply unit 71, or the second supplementary fiber supply unit 72, may be present. The first and/or second supplementary fiber supply units 71, 72 may supply fibers that are finer, i.e. have a smaller diameter, than the fibers supplied by the main fiber supply unit 70. Thereby, a fiberboard with upper and lower surfaces with smooth surface properties may be provided, and coarser fibers may be used in the core layer of the fiberboard.

Without further elaboration, it is believed that one skilled in the art may, using the preceding description, utilize the present invention to its fullest extent. The preceding preferred specific embodiments are, therefore, to be construed as merely illustrative and not limitative of the disclosure in any way whatsoever.

Although the present invention has been described above with reference to specific embodiments, it is not intended to be limited to the specific form set forth herein. Rather, the invention is limited only by the accompanying claims and other embodiments than the specific embodiments described above are equally possible within the scope of these appended claims.

In the claims, the term “comprises/comprising” does not exclude the presence of other elements or steps. Additionally, although individual features may be included in different claims, these may possibly advantageously be combined, and the inclusion in different claims does not imply that a combination of features is not feasible and/or advantageous.

In addition, singular references do not exclude a plurality. The terms “a”, “an”, “first”, “second” etc. do not preclude a plurality.

1. A forming and pre-pressing station for forming a fiberboard comprising compressed lignocellulosic fibers, the forming and pre-pressing station comprising a press arranged downstream of a forming belt, the forming belt being arranged downstream of a dosing station and at least partly at a lower vertical level than a delivery end of the dosing station, whereby lignocellulosic fibers may be transported from the dosing station to the press via the forming belt, further a pre-press is arranged over at least a part of the forming belt, the pre-press being arranged to compress a layer of lignocellulosic fibers by means of suction into a pre-compressed layer of lignocellulosic fibers before being fed to the press.

2. The forming and pre-pressing station according to claim 1, wherein the pre-press comprises an air-permeable mesh belt with a lower side arranged to be in contact with lignocellulosic fibers transported by the forming belt, an inner side of the mesh belt being arranged in communication with a vacuum box, whereby the lignocellulosic fibers may be pre-pressed over at least a portion of the lower side of the mesh belt into the pre-compressed layer of lignocellulosic fibers by evacuating air from the lignocellulosic fibers.

3. The forming and pre-pressing station according to claim 2, wherein the press is a belt press, and wherein the belt press and the forming belt are arranged in a non-overlapping manner, the air-permeable mesh belt of the pre-press being arranged in an overlapping manner over a lower belt of the belt press as well as over the forming belt, whereby the lignocellulosic fibers may be fed from the forming belt to the belt press by means of the air-permeable mesh belt; the belt press and the forming belt being arranged at a same vertical level.

4. The forming and pre-pressing station according to claim 2, wherein the pre-press comprises a first roller arranged at a receiving end of the pre-press and a second roller arranged at a delivery end of the pre-press, the receiving end facing the delivery end of the dosing station and the delivery end facing the belt press, the air-permeable mesh belt being arranged around said rollers, wherein the first roller is hollow and a second vacuum box is arranged within the first roller to apply a suction over a part of its circumference; the second roller being hollow and arranged for releasing the pre-compressed layer of lignocellulosic fibers by means of an air pressurized box arranged within the second roller.

5. The forming and pre-pressing station according to claim 1, wherein the pre-press comprises a third roller being hollow and a third vacuum box is arranged within the third roller to apply a suction over a part of its circumference, the third roller being arranged over a part of the forming belt and downstream of the dosing station, wherein the pre-press comprises an air-permeable mesh belt arranged around the third roller and a fourth roller.

6. The forming and pre-pressing station according to claim 4, wherein a top cover extends from the delivery end of the dosing station to the pre-press over a part of the forming belt not arranged under the pre-press to form a forming chamber in between the forming belt and the top cover.

7. The forming and pre-pressing station according to claim 1, wherein the pre-press comprises a wetting arrangement for wetting an upper and/or a lower side of the layer of lignocellulosic fibers before being fed to the belt press; and/or wherein the pre-press comprises a heating arrangement, such as a steaming arrangement, for pre-heating the layer of lignocellulosic fibers before being fed to the press.

8. The forming and pre-pressing station according to claim 1, further comprising a rotatable forming and dissolving roller being arranged at an end of the dosing station for feeding lignocellulosic fibers to the forming belt, wherein the forming and dissolving roller is arranged to engage with lignocellulosic fibers from the dosing station, whereby the lignocellulosic fibers may be dissolved and distributed into a layer on the forming belt; wherein the forming and dissolving roller is a spike roller; and/or wherein the forming belt and the dosing station are arranged in an overlapping manner.

9. The forming and pre-pressing station according to claim 8, further comprising a further rotatable forming and dissolving roller, the further rotatable forming and dissolving roller being arranged below said forming and dissolving roller, and/or the further rotatable forming and dissolving roller being arranged on essentially a same vertical level as the delivery end of the dosing station.

10. The forming and pre-pressing station according to claim 8, wherein the dosing station comprises a dosing belt, and wherein the rotatable forming and dissolving roller is arranged to rotate with a tangential speed higher than a linear speed of the dosing belt, the station further comprising a main fiber supply unit for feeding, such as gravimetrically feeding, lignocellulosic fibers to the dosing belt; a first profile correction system being arranged upstream the forming and dissolving roller, whereby the lignocellulosic fibers on the dosing belt may be arranged to a layer of lignocellulosic fibers with uniform height before reaching the forming and dissolving roller, and/or a second profile correction system being arranged downstream the forming and dissolving roller, whereby the lignocellulosic fibers on the forming belt may be arranged to a layer of lignocellulosic fibers with uniform height before reaching the pre-press.

11. The forming and pre-pressing station according to claim 1, wherein a difference in vertical level between the forming belt and the delivery end of the dosing station is less than 50 cm, wherein a difference in vertical level between a top of a receiving end of the forming belt and the top of the delivery end of the dosing station being less than 50 cm.

12. The forming and pre-pressing station according to claim 1, wherein the forming and pre-pressing station comprise a first supplementary fiber supply unit arranged upstream of the dosing station, and/or a second supplementary fiber supply unit arranged downstream of the delivery end of the dosing station and upstream of the pre-press.

13. A process for forming and pre-pressing lignocellulosic fibers to provide a fiberboard comprising compressed lignocellulosic fibers, the process comprising:
dissolving lignocellulosic fibers from a dosing station and distributing them into a layer on a forming belt, the forming belt being at least partly present at lower vertical level than a delivery end of the dosing station;
pre-pressing the layer of dissolved and distributed lignocellulosic fibers on the forming belt into a pre-compressed layer of lignocellulosic fibers by applying suction from above; and
pressing the pre-compressed layer of lignocellulosic fibers to provide fiberboard.

14. The process according to claim 13, wherein the layer of dissolved and distributed lignocellulosic fibers on the forming belt is further pre-pressed between an air-permeable mesh belt and the forming belt, and wherein the suction is applied by evacuating air from the layer of lignocellulosic fibers through the air-permeable mesh belt.

15. The process according to claim 14, wherein the pre-compressed layer of lignocellulosic fibers is pressed into a fiberboard by a belt press, wherein the compressed layer of lignocellulosic fibers is fed to the belt press by the air-permeable mesh belt.

16. The process according to claim 13, wherein the dosing station comprises a dosing belt, and wherein a rotatable forming and dissolving roller is arranged to dissolve fibers leaving the dosing belt, preferably the forming and dissolving roller is a spike roller, the spike roller rotating at a tangential speed higher than a linear speed of the dosing belt conveying the lignocellulosic fibers to the spike roller.

17. The process according to claim 13, wherein the lignocellulosic fibers:
are heated and/or wetted before being pressed into a fiberboard; and
at least 95 wt % (at 6% moisture content) of the lignocellulosic fibers passes through a metal wire cloth sieve width of 3 mm, and at least 50 wt % of the lignocellulosic fibers passes through a metal wire cloth sieve width of 630 μm; and/or
have a density of at least 210 kg/m³.

18. The process according to claim 13, wherein the fiberboard:
has a total thickness of 0.5 to 7 mm; and/or
has a density of at least 930 kg/m³.

19. The process according claim 17, wherein the lignocellulosic fibers:
are mixed with a binding agent; and/or
at least 25 wt % originate from re-cycled MDF and/or HDF.
